(19) United States
(12) Patent Application Publication
(10) Pub. No.: US 2024/0261741 A1
(43) Pub. Date: Aug. 8, 2024

(54) Flow-Path-Regulating Conformal Dip Tube

(71) Applicant: UNIVERSITY OF ALASKA FAIRBANKS, Fairbanks, AK (US)

(72) Inventor: Jonathan Kamler, Juneau, AK (US)

(21) Appl. No.: 18/431,433

(22) Filed: Feb. 2, 2024

Related U.S. Application Data
(60) Provisional application No. 63/483,081, filed on Feb. 3, 2023.

(51) Int. Cl. B01F 25/431; B01F 25/4314; B01F 25/432; B01F 101/00

(52) U.S. Cl. CPC B01F 25/4317; B01F 25/43141; B01F 25/4323; B01F 2101/2204

(57) ABSTRACT

A flow-path-regulating, dip-tube device is an adaptable, scalable, flow-through performance enhancement to any vessel-type, reaction containment apparatus. This apparatus is embodied as a reconfigurable, quasi-“dip tube” which modularly improves reaction processing, performance, and efficiency. This apparatus increases operational flexibility, adaptable design, and vastly improves efficiencies and flow predictability of vessel-type reaction containers by retrofitting them with benefits of tubular reaction-containment configurations. Internally, the dip-tube device defines one or more closely spaced, functional voids which operate as fluid channels that can be configured in various geometric or topologic arrangements. The dip-tube apparatus is widely scalable, provides high thermodynamic efficiency, manufacturing simplicity, and affordability for varied operations through additive manufacturing, and has a compact physical footprint conformally fitted within a parent container.

### CROSS-REFERENCE TO RELATED APPLICATION

This application claims priority to and the benefit of the filing date of U.S. Provisional Patent Application No. 63/483,081, filed Feb. 3, 2023, the entirety of which is hereby incorporated by reference herein.

### BACKGROUND

Traditional dip tubes used in pressure-vessel-type reaction-containment devices allow introduction or extraction of educts at the bottom of the vessel through openings other than at the bottom of the vessel. Traditional vessel-type reaction-containment devices use such dip tubes to improve thermal transfer efficacy and educt mixing by augmenting their combination of relatively compact volume-to-footprint ratios, vigorous active agitation, and residence-time management. Vessel-type dip-tubes devices in continuous-flow configurations, however, are most commonly limited relatively short, straight pieces of point-A-to-point-B tubing or pipe which can be added through vessel opens in a straightforward manner. Short, straight dip tubes fail to ensure residence-times and associated reaction efficacy via predictable heat transfer during reactions afforded by tubal configurations. Indeed, flow-through, pressure-vessel configurations along with their commensurate dip-tube modifications are limited to relatively simple designs with inlets, outlets, and agitators all commensurately serving a single functional void. Flow-through vessels that rely on passive mixing modifications such as baffles and other types of flow diverters have suffered reaction inefficiencies resulting from unpredictable and incomplete reactant mixing, sub-optimal heat-transfer efficiency, and considerable heat loss. Active agitation presents additional challenges due to unreliable and expensive seals when operating at high temperatures and pressures, especially with hazardous or corrosive chemicals. These challenges have driven processes away from attractive vessel-centric, cost-containment advantages such as small footprint, straightforward pressure certifications, simple designs, maintenance ease, and product-line manufacturability in favor of more predictably reliable process management along with higher construction costs and much larger footprint of tubular configurations.

### SUMMARY

Disclosed herein, in one aspect, is an apparatus for controlling flow in a parent container. The apparatus comprises a parent container defining an interior. A device body is receivable into the interior of the parent container. The device body defines at least one flow path. The at least one flow path has an inlet and an outlet. The body has an outer surface that is configured to be received within and circumferentially bias against the parent container.

Also disclosed herein is a device that is configured for receipt into an interior defined by a parent container. The device includes a device body. The device body defines at least one flow path. Each flow path of the at least one flow path has an inlet and a corresponding outlet. The device body has an outer surface that is configured to be received within and circumferentially bias against the parent container.

Methods of using the device and apparatus are also disclosed.

### BRIEF DESCRIPTION OF THE DRAWINGS

The accompanying drawings, which are incorporated in and constitute a part of this specification, illustrate embodiments and together with the description, serve to explain the apparatus:

FIG. 1 is a diagram showing vertically oriented generally cylindrical apparatus body (bisected halves shown via cutaways), along with single internal functional void (fluidic channel) orientations and exemplary inlet and outlet ports, all received inside a typical pressure-vessel or container void (all illustrated via component cutaways).

FIG. 2 is an exploded-view diagram of the components of FIG. 1 (showing fewer cutaways).

FIG. 3 is a diagram showing single-channel dip-tube device with tetrahedral (diamond-shaped) functional void orientation details.

FIG. 4 is a diagram showing two-channel dip-tube device with tetrahedral (diamond-within-a-diamond shaped) functional void orientation details.

FIG. 5 is a diagram showing overlapping (screw-thread-like) annular structure favored by generally tetrahedral (diamond-shaped) or any symmetrical angular channel-profile arrangements.

FIG. 6 is a diagram showing dip-tube device outer surface spiral screw-thread-like groove that functions as a flow-controlling quasi-channel between the dip-tube device and the inner vessel surface.

FIG. 7 is a diagram showing oscillatory flow direction change between annular channel layers.

### DETAILED DESCRIPTION

Before the present apparatus is disclosed and described, it is to be understood that the apparatus is not limited to specific configurations, or to particular implementations. It is also to be understood that the terminology used herein is for the purpose of describing particular embodiments only and is not intended to be limiting.

As used in the specification and the appended claims, the singular forms “a,” “an” and “the” can optionally include plural counterpart unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” the approximation values form another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Throughout the description and claims of this specification, the words “reactor” and “vessel” along with descriptor combinations such as “pressure vessel”, “parent vessel”, “container”, “containing vessel”, “parent container” “vessel-type reactor”, and “pressure-vessel-type reactor” in a non-limiting manner all generically and interchangeably meaning “reaction containment device” and is not intended to exclude, for example, any of a wide, embodiment variety such as a tanks, vats, tubes, or pipes.

Throughout the description and claims of this specification, the words “insert” and “dip tube” along with descriptor combinations such as “vessel insert”, “parent vessel insert”, “pressure-vessel insert” and “flow-controlling insert” in a non-limiting manner all generically and interchangeably meaning “insert” and is not intended to exclude any of reasonable embodiment description.

As used herein, “coaxial” can be understood to refer to paths traveling generally along the same axis. Coaxial channels need not be straight; rather, in some aspects, coaxial channels can be curved (e.g., helical). Coaxial channels can further be adjacent each other, each following a shared axis.

Disclosed are components that can be used to perform the disclosed methods and configurations. These and other components are disclosed herein, and it is understood that when combinations, subsets, interactions, groups, etc. of these components are disclosed that while specific reference to each various individual and collective combinations and permutations of these may not be explicitly disclosed, each is specifically contemplated and described herein, for all apparatus configurations.

The present dip-tube apparatus may be understood more readily by reference to the following detailed description of exemplary embodiments and the specific features included therein and to the Figures and their previous and following description. It should be noted that channel profiles may also be dictated by various fluid and associated rheological specifications through which the channels are configured to allow passage, including reactant educts, slurries, oxidants, energy-exchange fluids, ionic fluids, molten metals, molten salts, or other suitable reactants. Channel profiles shown and embodied herein are for illustrative purposes and should not be considered limiting. Furthermore, each dip-tube device functional void can have one or more separate inlet and outlet ports allowing continuous, unobstructed fluid flow. In some optional aspects, the dip-tube device inlet or outlet ports can open into the parent container's void (e.g., via a hole or opening in the dip-tube device surface) rather than a connection structure, further enabling the insert apparatus to better function as the intended quasi-“dip tube” for the parent container.

### Introduction

Pressure-vessel dip-tube device embodiments described herein can advantageously exemplify internal shapes of any vessel-type device (also referred to herein as a “vessel” or a “parent container”) and can also serve as de facto dip tubes, requiring little or no modification to the vessel in which the device is received, thereby advantageously capitalizing on existing vessel-pressure certifications. Rather than serving as the reaction containment apparatus per se, dip-tube-like devices forgo the ability to serve as a standalone pressure-containment devices by actually relying on capabilities of the parent container. Indeed, nothing herein should be construed in any way to require that the disclosed apparatus be a standalone reaction containment device, nor does the disclosed apparatus improve on any type of reaction containment device as such without a parent container. In some exemplary aspects, the separate, parent container can be critical to functional context of the proposed apparatus. Specifically, dip-tube device embodiments covered herein function as elaborate dip tubes inside a reaction-containment device, but radically improve on and modify standard dip tube configurations by conformally filling the entire container void. This radical departure from that of traditional dip-tube configurations essentially converts traditional vessel-type containers into hybridized configurations that retain advantages such as small-footprint, straightforward design, and known pressure certifications, while advantageously adding predictable-residence-time flow regimes, intimate wall contact, high-surface-area-to-volume ratios along with enhanced thermal dynamics of flow-through, tubular, reaction containment.

Dip-tube devices embodied herein can preferentially be used with vessels, tanks, or pipes that can be opened in order to provide easy access to the entirety of the internal functional voids. Such access can optionally be via removable lids or ends that in turn allow easy access to the internal parent-container voids, such that dip-tube devices can be sized to conformally fit interior dimensions of said pipes or vessels. Easy access through a removable lid enables straightforward dip-tube device installations, ostensibly without modifying parent containers in any permanent manner and thus avoid adversely affecting parent-container pressure and temperature certifications. Plus, removable-lid configurations readily enable future access to dip-tube devices for maintenance, removal, or replacement. Alternatively, if the intended parent containers were not fitted with a removable lid, dip-tube devices can be permanently incorporated into the containing vessel at the time of construction when the ends are welded in place or added by cutting off a container end and then reattaching it following dip-tube device installation. Less-optimized installation embodiments might include sizing the dip-tube device to fit through vessel access ports or modularly fitting multiple dip-tube devices together inside a vessel or parent container through access ports. One or more of the dip-tube device functional voids may open to the parent container's internal void, thereby allowing fluid to pass freely between the parent container void and dip-tube device void(s) through said port or opening.

Furthermore, dip-tube devices can be fitted together as modularly discreet sections or preferentially fabricated from as single pieces of material as is traditionally the case with simple one-piece dip tubes. Preferred construction methods for a single-piece configuration can include any of various additive manufacturing processes (also known as 3D printing) depending on the specific materials and capabilities needed, but other manufacturing methods, such as investment casting, lost-wax casting, gel casting, or a variety of similar methods can also be used to manufacture the apparatus. Additive manufacturing advantageously allows for single-piece or modular configurations along with internal fluid channels integrated into a single piece resulting in little or no subtractive machining.

One exemplary dip-tube device embodiment comprises a device with outer dimensions conformally fitted to the generally cylindrical internal form factor of typical vessel configurations (notably with rounded, conical, or flat end surfaces as needed). Furthermore, an exemplary embodiment of a dip-tube device channel arrangement can comprise a single channel of concentrically arranged axially helical coils or axial oscillations that connect annularly, thereby forming continuous serpentine paths. Helical coils are substantially arranged in annular rings situated concentrically around the apparatus axial center. Apparatus structure and internal annularly arranged serpentine channels efficiently and advantageously “pack” very long tubular reaction zones into compact form factors that can conformally fit inside corresponding pressure-containment-vessel internal form factors. Additional coaxial multi-channel configurations can advantageously offer heat transfer optimization options along with simultaneous processing multiple, segregated fluids in a single vessel. Annular structures create very long, continuous channels with correspondingly high surface-area-to-volume ratios in a compact space, thereby accommodating tunable fluidic velocities coupled with very low thermal losses.

Customized channel, cross-sectional profiles allow for unique proximal channel arrangements and orientations to capitalize on fluidic isothermal conditions and energetic dispersion. Notably, rather than being (ostensibly round) tubes or pipes that have been bent and coiled into shape, channels function as linear voids inside the apparatus comprising limitless possible geometries or topologies in terms of cross-sectional shapes, rotational pitch, area, and diameter. Channel geometries or topologies can be constant or varied along their linear paths in terms of size and/or proximal spacing via differing wall thicknesses. Notably, channel cross-sectional profiles which are varied along their linear path can advantageously enhance key flow-related performance parameters, including, but not limited to, managing pressure losses, creating flow-rate-altering pinch points, or regulating agitation. However, all channels in the shown embodiments maintain substantially constant relative profile geometries including axiality, concentricity, annularity, and radiality across the apparatus space (with the exception that for illustrative purposes only, channel profiles substantially transition to round geometries at the inlet and outlet ports).

Operational needs along with design specifications may be addressed by mixing and matching channel cross-sectional geometries in various combinations or permutations such as, for example, generally tetrahedral (diamond-shaped) topologies to improve buildability along with compact channel-packing. There is no preferred embodiment in terms of the number of channels, individual profile shapes, or geometric channel orientations due to the fact that different designs can serve many different purposes including process or physical footprint optimization.

Interlocking, overlapping, or proximally staggered channel-profile embodiments offer especially advantageous benefits in fissile applications, wherein such overlaps force escaping neutrons or other irradiative energetics to pass through or intersect surrounding breeder and moderator fluids. Indeed, overlapping or interlocking profiles ensure that there is no direct, straight-line efferent path from neutron-producing fluid to the outer surface without bisecting moderating fluids or structures. Consequently, neutron capture likelihood by surrounding fluids increases, thereby increasing moderation, improving breeding efficiency, and reducing shielding requirements. Fluid channels can advantageously inhibit wear and avoid galling common in traditional fissile applications, due to the fact that the device disclosed herein requires no moving parts which could jam or gall. The outer vessel can provide shielding and strength, by for example using one collection of suitable materials, while the dip-tube device structure provides operational controls, possibly using a different material more suited for the role.

Furthermore, said fluids may be dynamically varied in terms of density, composition, or flow rates in order to dynamically calibrate moderation and control characteristics eliminating the need for moving parts. Plus, configured as an insert, the dip-tube device can be quickly swapped out from service with minimal down time without permanently modifying or replacing the entire vessel apparatus.

Several independent, annularly adjacent helical layers of fluid channels allow reactant and product mixtures to isothermally progress through the reaction space in a uniform manner, thereby promoting highly efficient isothermal operation and low pressure losses along the channels. In embodiments comprising multiple coaxial channels, the dip-tube device can allow temperature-gradient regulations across successive annular channel sections (the helical layers) via heat transfer to educts prior to mixing and heat extraction from products prior to discharge. Educt and product flow rates can be varied in order to control and optimize heat transfer between fluids within the inherently high-surface-area-to-volume-ratio channel structure. Closely spaced channels fill the entirety of the available apparatus, thereby providing precise, uniform, and accurate isothermal control throughout the apparatus space while still advantageously maintaining high educt volume-to-mass ratio. Plus, uniform isothermal distribution throughout the apparatus minimizes localized thermal spikes or hot spots.

### Exemplary Embodiments

As will be appreciated by one skilled in the art, the dip-tube device can be embodied in various ways. Non-limiting exemplary embodiments of the apparatus are described below with reference to illustrations of exemplary configurations.

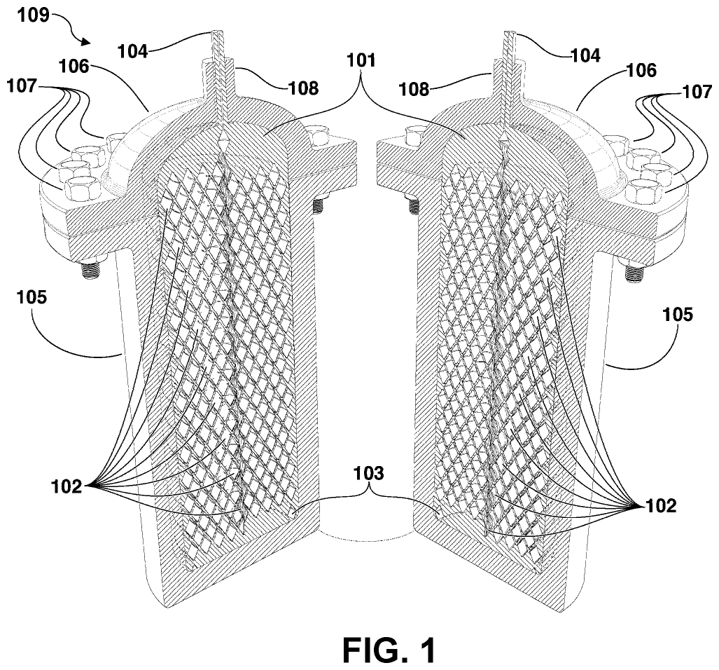

An apparatus 109 shown in FIG. 1 can comprise a dip-tube device body 101. The dip tube device body 101 can comprise, or be formed from, any suitable material (e.g., metal, ceramic, plastic, composite, or other similar/suitable constituents depending on operational conditions). The dip-tube device body 101 can define one or more internal functional voids 102. An exemplary configuration of internal functional voids 102 is shown as a single, continuous, internal four-sided (e.g., diamond-shaped) channel, coaxially situated in adjoining annular layers (e.g., nine layers, as shown in the illustrated embodiment), along with a single inlet 103 and a single outlet 104. The single inlet 103 and the single outlet 104 can be directionally interchangeable.

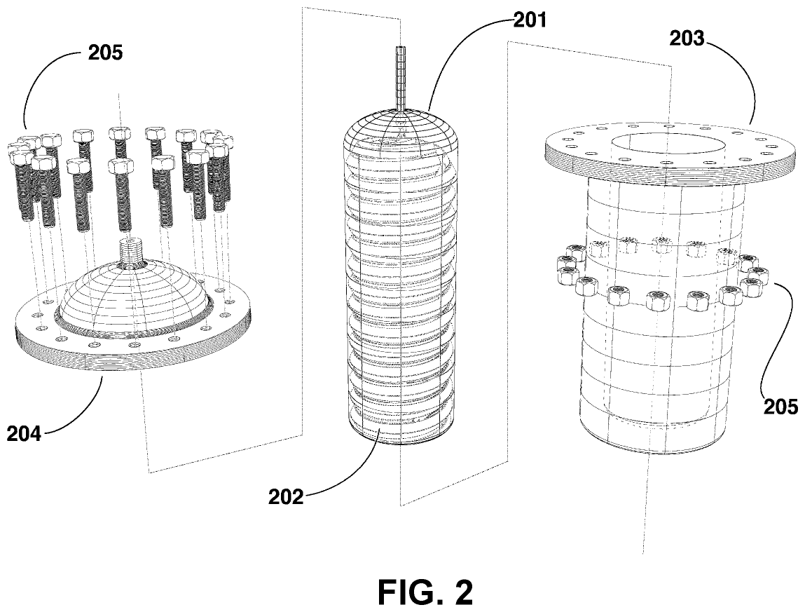

The dip-tube device body 101 can be received within a vessel-type parent container 105 (shown as bisected halves). The parent container 105 can comprise a main portion and a lid 106 (e.g., optionally, a flanged lid) that is coupled to the main portion. The parent container 105 can comprise an inlet/outlet 108. The lid 106 can be secured to the main portion of the parent container 105 via fasteners 107 (e.g., bolts, screws, etc.) The parent container 105 can, in alternative aspects, be welded rather than using bolts. Welding can avoid complex seal mechanisms and ensure no leaks to thereby provide a higher seal reliability, whereas use of fasteners 107 can enable internal maintenance and inspection in favor. The components of the apparatus 109 as shown in FIG. 1 are exploded in FIG. 2 for clarification of their proximal orientations (without cutaways) comprising the dip-tube device body 201 (which can correspond to the dip-tube device body 101 of FIG. 1) with internal functional voids 202 (which can correspond to the internal functional voids 102 of FIG. 1), parent containment vessel 203 (which can correspond to the parent containment vessel 105 of FIG. 1), corresponding lid 204 (which can correspond to the lid 106 of FIG. 1), and fasteners 205 (which can correspond to the fasteners 107 of FIG. 1).

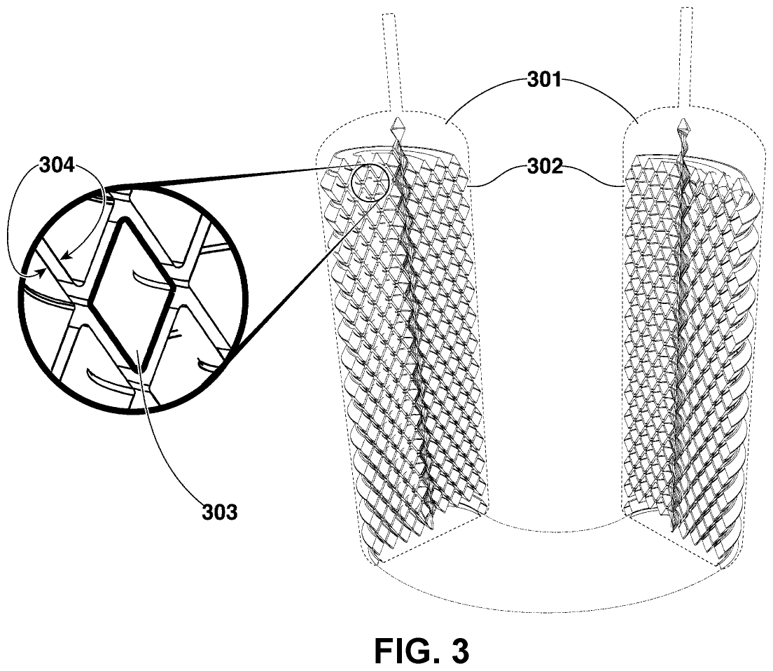

The dip-tube device as shown in FIG. 3 comprises exemplary internal details of the insert body 301 (dashed outline, which can correspond to the dip-tube device body 101 of FIG. 1), wherein one or more internal functional voids 302 (which can correspond to the internal functional voids 102 of FIG. 1) serve as fluidic channels (notably only one continuous void shown in this embodiment). Notably, an exemplary single-channel embodiment of the apparatus as shown in FIG. 3 comprises internal functional voids 303 provided in a tetrahedral (e.g., diamond-shaped) cross-sectional profile configuration 303 (with a detail view showing tetrahedral details enlarged). Tetrahedral (e.g., diamond-shaped) profiles favor consistent channel spacing and uniform wall thickness (shown as spacing 304 between channels), while also optimizing additive buildability. Tetrahedral/diamond shapes can, in further aspects, be bisected into two or more channels (e.g., to form two symmetrical triangular profiles). In alternative aspects, channels can be any suitable cross-sectional geometric shape or topology that fits the space, including circular or substantially circular cross sections. In some aspects, circular cross sections can exhibit the lowest fluidic friction and correspondingly lowest flow resistance due to lowest surface-to-volume ratios and therefore can be least prone to scaling and plugging. It is contemplated that polygonal cross sectional profiles such as the illustrated tetrahedral profiles can advantageously be relatively inexpensively manufactured.

The internal void structure can form long, serpentine coaxially parallel channels that offer extremely efficient isothermal control, thereby suitably altering operational parameters to meet nuanced reaction specifications. Counter-flowing, thermal-exchange fluids in the channels can also provide start-up heating capabilities. In this way, the apparatus 109 (FIG. 1) can be brought to start-up temperatures prior to introducing actual reaction educts. Conversely, thermal energy can be harvested or dissipated via exchange fluid when operationally managing exothermic reactions. Helically serpentine, coaxial tubular flow regimes can also be especially advantageous for processing high-exegetic reactants under exothermic autogenic conditions. For example, the temperature of the apparatus 109 can rise at or near the axial center while remaining cooler radially outwardly or vice versa. The parent vessel 105 into which the dip-tube device body 101 is conformally fitted can provide structural pressure containment. For example, in some aspects, the dip-tube device body 101 can be formed with a shape that is configured for complementary receipt in the parent vessel 105. In other aspects, it is contemplated that the dip-tube device body 101 can be deform or flex in order to be complementarily received in the parent vessel 105. The dip-tube device body 101 can independently manages fluid and thermal dynamics. Channel flow dynamics can be reversed for isothermal management of endothermic reactions. Likewise, external heating of the parent vessel 105 can conductively transfer heat to the fluid as it flows between the inner wall of the vessel and the exterior surface of the dip-tube device body 101. The dip-tube device body 101 can, in turn, transfer that heat from the parent vessel 105 to the interior of the dip-tube device (e.g., to the internal void structure 102) via advective flow through internal dip-tube device channels.

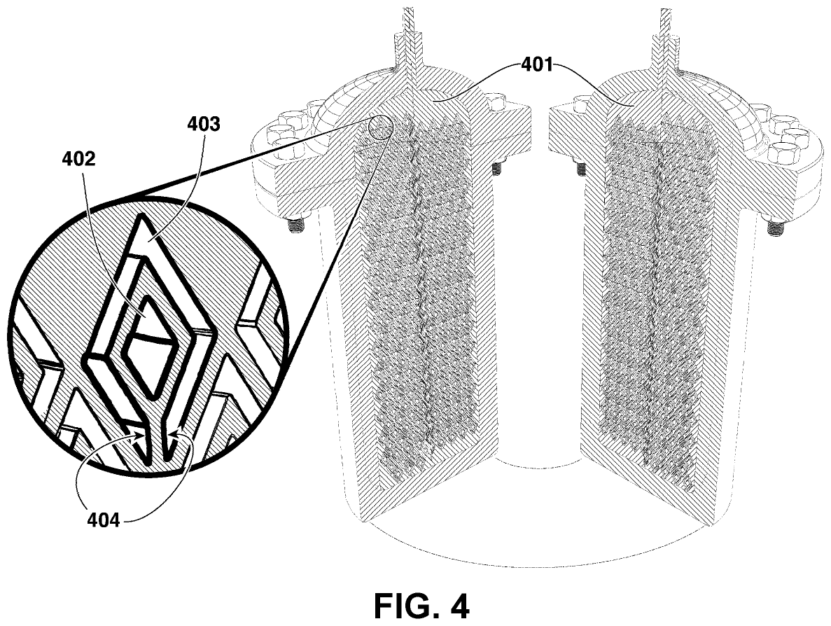

Referring to FIG. 4, in some optional aspects, the dip tube device can comprise dip-tube device body 401 (which can correspond to the dip-tube device body 101 of FIG. 1) with a two-channel configuration in which a first channel 402 is adjacent, partly surrounded, or entirely surrounded by a second channel 403. For example, in one exemplary embodiment of the dip-tube device, as shown in FIG. 4, the dip-tube device body 401 can have a two-channel tetrahedral-profile configuration (e.g., diamond 402 within a diamond 403). An inner portion of the dip tube device body 401 (which can correspond to the portion of the dip tube device body defining the inner channel can be supported by a support 404 (shown as a single pedestal-like structure that bisects the bottom of the outer channel in this non-limiting example). In further or alternative aspects, inner channel supports 404 can also bisect the top of the outer channels, thereby functioning as hangers for the inner channels rather than as pedestals. The supports can actually be configured from any direction, depending on the specific design requirements and can be singular as shown or in multiples if so needed.

Outer surrounding channels, in this case larger external channels 403 of a two-channel, tetrahedral-profile configuration (e.g., diamond 402 within a diamond 403) can be precisely reflected and simultaneously annularly nested in order to connect a channel in one annulus to the corresponding channel in the next. Doing so axially coils the channels tightly around the center of the dip-tube device in a somewhat oscillatory manner while maintaining coaxial paths, thereby maximizing run length of the channels while optimally minimizing overall size necessary for the apparatus to conformally fit within the confines of a parent, containment vessel.

If heat transfer between channels is the objective, two fluids can flow in opposite directions in order to allow counter-flow heat transfer from fluid in one channel to the fluid in the separate, adjoining channel conductively through their shared channel wall. In exemplary aspects, one fluid can function as a heating fluid, thereby transferring its heat to fluid flowing in the opposite direction as is commonly the case in various counter-flow heat exchanger configurations. Alternatively, fluids may also flow parallel in the same direction, albeit segregated in the two separate channels, thereby ensuring comparable heating of the two fluids simultaneously. In further optional aspects, coaxial voids can logically be extended and scaled to more than two channels, thereby comprising as many channels as needed for the specific desired application.

Educt flow through dip-tube device channels can closely mimic that of true tubal configurations, albeit within the confines of a traditional pressure vessel. Dip-tube device flow regimes, therefore, can improve reactant mixing, otherwise difficult to produce in a single-chamber pressure vessel, via secondary spiraling fluidic flows and eddy currents. Consequently, the dip-tube device disclosed herein provides more intimate contact and chaotic intra-fluidic turbulence than would be the case in a pressure vessel alone. Multiple helical flows can produce high shear forces that, in turn, can serve multiple functions including, for example, better mixing and advantageous wall scouring. Moreover, the high-shear flow patterns can flush adhering films from channel walls that would otherwise impede flow and thermal transmission. If necessary, mixing can be intensified and flow laminarity reduced by adding static mixing structures such as pinch points, fins, inner-wall textures, twists, spirals, or similar adaptations positioned along the channel structure fluidic flow path and/or simply adjusting flow rate and velocity.

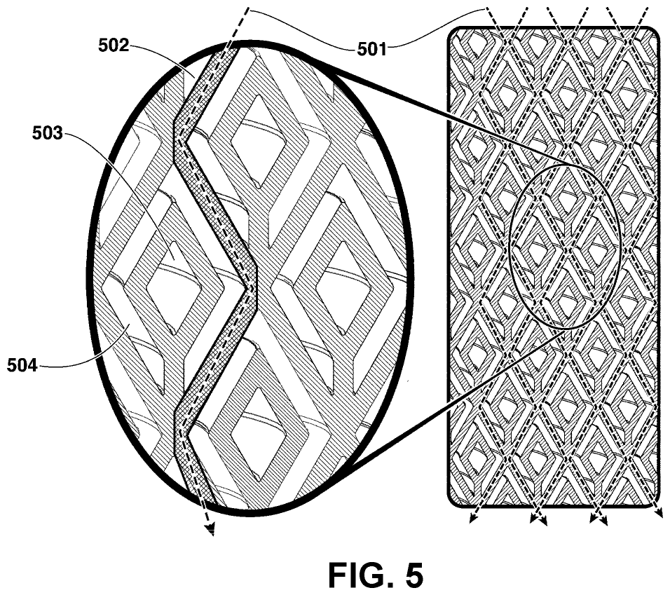

As shown in FIG. 5, channel proximities embodied herein (particularly symmetrical angular profiles such as tetrahedrons or those with opposing faces generally resembling triangles) allow cross-sectional geometric profiles of each concentrically successive layer to be nested or overlapping (both axially and radially), with one annual spiral overlapping with another thereby (shown via dashed, zigzagging, generally vertical lines 501). Opposing faces 502 of adjoining annular layers can resemble threads of a bolt oriented into threads of a nut. The resulting nesting can orient functional voids adjacent to one another in a tightly spaced, coaxial, parallel manner, which can maximize efficiency and minimize overall apparatus size. Overlapping annular layers can structurally aid axial control of heat transfer, either towards or away from the center of the apparatus. At the end of each annular layer, a coaxial channel assemblage can turn or folds back into the next concentric layer along shared edges of their adjoining profiles, thereby creating comparably similar annular structures of oscillating axial arcs and coils. Each concentric, multichannel assemblage can axially coil or axially oscillate around the center of the apparatus forming axially concentric layers. Close spacing and inherent nesting of adjoining annular channel layers can improve construction-material-demand efficiencies. Furthermore, the apparatus can be formed by additive-manufacturing methods. Connected channel-coil assemblages can maintain proximally parallel paths, thereby nesting the annular structures within each other, facilitating efficient flow regimes, heat transfer, and reaction efficiency. Smaller interior channel 503 orientations linearly and proximally correspond to that of larger outer channels 504 enabling connections from corresponding channels in adjoining annuli.

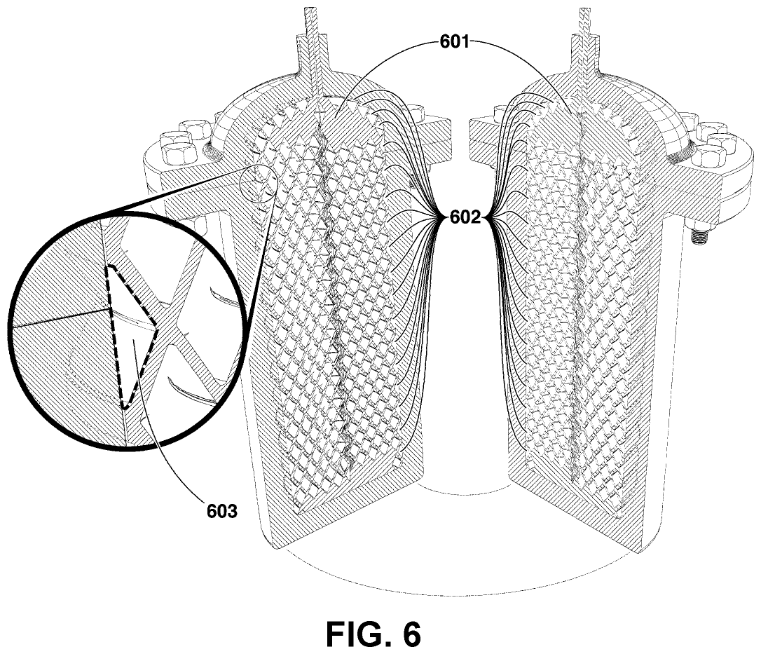

As shown in FIG. 6, the dip-tube device body 601 (which can correspond to the dip-tube device body 101 of FIG. 1), can be fashioned with a surface channel 602. The surface channel 602 can have the cross section of half of an internal functional void (Inset: 603). In other aspects, the cross section of the surface channel 602 can have any suitable shape. Fluid flow between the outer surface of the dip-tube device and the inner surface of the parent container 105 can progresses along the surface channel 602 in either direction as desired or needed. Flow efficiency through the surface channel 602 can greatly depends on the conformal tolerance between the dip-tube device and the parent vessel. Surface channel 602 can advantageously be formed at the time of the dip-tube device fabrication or can be added as a post-manufacture machined feature. Flow through the surface channel can increase residence time, resulting in more intimate contact and improved heat transfer between the fluid and the dip-tube device and parent-container surfaces (all illustrated via component cutaways).

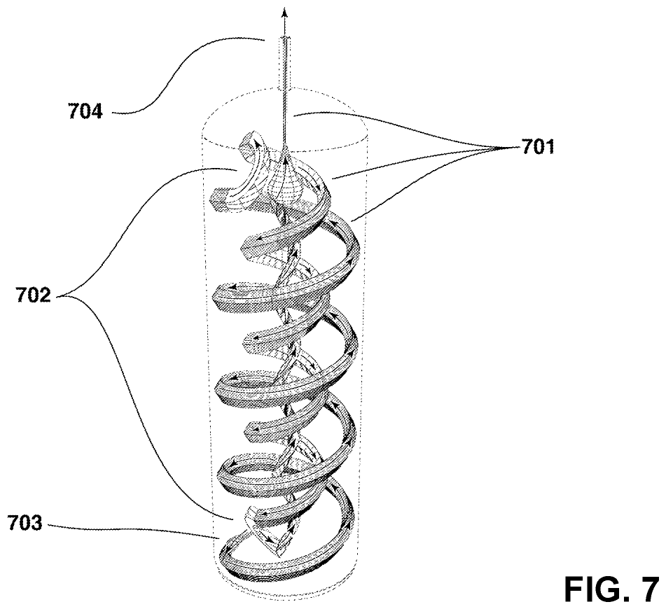

Radially concentric, annular layers of the internal functional void as shown in FIG. 7 can fold into adjacent layers (three layers in this case with exaggerated spacing for illustrative clarity: 701), thereby reversing the fluid flow direction via conformal U-turn or switchback structures with each successive layer 702. Fluid can flow in the opposite direction between any two respectively adjacent radially concentric layers. The linear flow direction of one channel (only one channel is shown for clarity) can be generally a directional oscillation as it progresses from one annular layer to the next. That is, the flow can reverse rotationally from clockwise to counterclockwise and back again as it proceeds from the input port 703 until to the respective output port 704. Closely spaced, conformally parallel-channel orientations can allow efficient energetic transfer when two adjacent channels have fluidic flows in opposite directions. Concentric annular layers can structurally aid radial thermal energetic redistribution, either towards or away from the center of the dip tube apparatus.

Exemplary embodiments having an even number of annular passes create an even number of annular, concentric layers, thereby advantageously lending themselves to input and output ports on the same axial end of the apparatus. It is contemplated that a configuration with an odd number of concentric annular layers can alternatively accommodate input and output ports on opposite ends of the apparatus. These options are non-limiting, with custom configurations allowing for input and output ports positioned anywhere needed or desired on the exterior of the dip-tube device.

Fluid flow within any given annular layer (e.g., a segment) shown in the non-limiting embodiments herein can generally proceed from one axial end of the device toward the other axial end and then can connect to successive annular channel layer via precise bends. Channels in the exemplary embodiments of are generally helical forms, which can impart changes in direction to the fluids for adjoining coaxial channel assemblage annuli. Channels can share walls. In this way, the walls can serve as fluidic containment boundaries as well as direct-contact, thermal-transfer conductors, thereby serving as thermal exchange interface surfaces between separated fluids.

Each radially concentric, annular channel layer can fold into the adjacent channel layer, thereby reversing fluid flow direction with each successive layer. Therefore, fluid can flow in the opposite direction between any two respectively adjacent radially concentric layers. Linear flow direction of one channel can be generally a directional oscillation as it progresses from one annular coil layer/segment to the next. That is, the flow can reverse rotationally from clockwise to counterclockwise and back again as it proceeds from the input port to the corresponding output port. Closely spaced, parallel-channel orientations can allow efficient energetic transfer when two adjacent channels have fluidic flows in opposite directions. Concentric annular layers can structurally aid radial thermal energetic redistribution, either towards or away from the center of the apparatus.

Exemplary, non-limiting embodiments contained herein can provide advantageously thin, internal shared walls between coaxial, helical annular channels, thereby using less than half of the material that would be required to produce a similarly functioning device by traditional bending, coiling, and welding. Additionally, considerably longer channel runs can be conformally fitted into the same footprint than would be the case with traditional bending and coiling. Automated production via additive manufacturing reduces production man-hours for a similar tubular arrangement by orders of magnitude, thereby creating a significant economic savings. Furthermore, serpentine channel structures integrated into apparatus structures can be preferentially produced via additive manufacturing, thereby offering advanced production methods not possible via traditional bending, coiling, and welding methods.

Thin-walled dip-tube device fluid channels embodied herein can sufficiently handle any high temperatures and high pressures within certification specifications commensurate with that of any parent vessel or container. A parent container can advantageously allow the much thinner, internal, shared channel walls of the dip-tube device to safely contain potentially very high fluid temperatures limited only by the properties of the construction material and pressure commensurate with that of the parent container. The dip-tube device body 101 (FIG. 1), therefore, can function as an extension or modular, non-permanent, performance enhancer for the parent vessel or container. Pressure differentials across thin walls of the dip-tube device can remain relatively low (i.e., a few psi to a few hundred psi) and only sufficiently high to maintain fluid flow, even while the pressure contained by the parent container is much higher (e.g., thousands of psi). The dip-tube device can, therefore, automatically inherit its pressure rating from that of the parent container.

It is contemplated that individual channel wall thicknesses would need to be much thicker to contain those same high temperatures and high pressures if the same complex geometries and topologies were produced in stand-alone, bent, coiled, and welded tubing, and notably those thicker walls would not be shared by more than one adjoining tube. Plus, the dip-tube device may need a much thicker outer wall and difficult-to-achieve pressure certifications if it were to serve as a reaction-containment apparatus of some kind in its own right.

Coiled-tubing dip tubes are a common modular approach for adding flow-determinant residence time to vessel-type apparatus. Combining helical gyrations and oscillations via additive processes solves problems associated with coiled-tubing dip tubes by providing a stronger, lighter, more-compact, safer, and simpler design, along with simpler, automated production. Indeed, the dip-tube device described herein provides for much easier, entirely automated construction of a vessel insert or dip tube with continuous annular in-line flow, which is easily incorporated and controlled via a much more efficiently modular annular structure. Furthermore, additively manufacturing the dip-tube device allows for any desired fluidic channel shapes, proximal orientations, and dimensions, which would otherwise be nearly impossible to manufacture via traditional tube production, tube coiling, and pipefitting processes. Additive production advantages are especially beneficial for coaxial, multi-channel design considerations.

The dip-tube devices disclosed herein (e.g., long-channel-run dip tubes) can modularly solve flow and residence-time issues of conventional dip tubes by bringing tubal advantages as post-production, retrofit modifications to vessel-type devices and as single-unit construction or as multiple, conjoined modules that can conformally fit inside existing vessel-type devices. The dip-tube devices disclosed herein can optimize heat transfer, efficiency, residence time, and reaction speed, while nimbly doing so within known vessel footprints and while also capitalizing on established vessel pressure certification standards.

Collectively, beneficial features resulting from the additive-manufacturing-enabled designs for this apparatus substantially lower capital costs, vastly reducing physical form footprint and uniquely facilitating portable applications. Additively manufactured dip-tube devices with customized, internal serpentine channel geometries or topologies also improve operational efficiency.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1A: A flow-control dip-tube insert apparatus comprising:
a. structural conformity to internal geometry of a parent container;
b. one or more internal functional voids which act as fluid channels;
c. corresponding inlet and outlet ports for each internal functional void allowing continuous, unobstructed fluid flow; and
d. internal configuration such that functional-void proximal orientations optimally tune parent-container efficiency, optimally tune parent-container residence times, and conform to parent-container internal footprint.

Aspect 2A: The apparatus of aspect 1A, further comprising one or more internal functional voids with serpentine, coaxially parallel, yet separated flow paths to advantageously and thoroughly mix fluids.

Aspect 3A: The apparatus of aspect 1A or 2A, further comprising operational pressure rating derived directly from that of a parent container, thereby advantageously capitalizing on existing parent-container certifications and operational temperatures limited only by material of construction.

Aspect 4A: The apparatus of aspect 1A-3A can advantageously embody shapes conformally compatible with internal geometries of any parent container (including, but not limited to tanks, vats, and pipes) and serves as a de facto “dip tube” for said containers, requiring little or no modification to the container itself.

Aspect 5A: The apparatus of aspect 1A-4A, further comprising structure that is configured to integrate with the parent-container lid or built as a fixed-configuration replacement for said lid, but preferably embodied as a “dip tube” insert attached to pipes feeding through the lid into the container cavity and/or through the container body.

Aspect 6A: The apparatus of aspect 1A-5A, wherein the flow-control dip-tube insert apparatus does not function as a standalone reaction containment device nor does the apparatus improve on any type of reaction containment device without a parent container, thus critically requiring a separate, parent container for functional context.

Aspect 7A: The apparatus of aspect 1A-6A, further comprising flexible material choice and structure that is configurable, operable, and replicable in one or more of a variety of materials including: metal, ceramic, sapphire, quartz, glass, plastic, and/or similar constituents (e.g., composites or function graded materials), and such materials can advantageously be of far less strength and durability than that of the parent container.

Aspect 8A: The apparatus of aspect 1A-7A, further comprising a structure that is porous, non-porous, or composed of a mixture of porosities in order to optimize corrosion resistance, strength, surface area, and/or durability. In some aspects, the device body can comprise a porous material. Optionally, the device body can be fabricated from a porous material. In other aspects, the device body can comprise a frame and a porous coating can be applied thereto. It is contemplated that the porosity can increase surface area to for catalytic purposes.

Aspect 9A: The apparatus of aspect 1A-8A can advantageously use suitable materials (e.g., iron, nickel, gold, etc.) to enhance, intensify, and optimize catalytic “wall effect” via intimate contact with the high-surface-area-to-volume-ratio dip-tube structure.

Aspect 10A: The apparatus of aspect 1A-9A, further optionally comprising external textures or patterns that can function as quasi-channels between the dip-tube device and containing vessel's internal wall.

Aspect 11A: The apparatus of aspect 1A-10A, further comprising functional voids that carry ionic fluids, molten metals, or other energy-transfer fluids to thermally regulate the apparatus and associated reactions.

Aspect 12A: The apparatus of aspect 1A-11A, further comprising internal functional voids customized to specific engineering requirements including, but not limited to, strength, spatial conformity, counter-flow, compactness, mass transfer, heat transfer, energy transfer, flow laminarity, flow annularity, shear forces, flow restrictions, pinch points, textures, friction, and smoothness.

Aspect 13A: The apparatus of aspect 1A-12A, further comprising internal functional voids of one or more annularly nested linear topologies along a longitudinal path axis, including, but not limited to, spirals within spirals within spirals, zigzags, helical, rectangular spirals, corkscrew, oscillatory, coiling, curving, twisting, winding, sinuous, circuitously torturous, or otherwise conceivable paths.

Aspect 14A: The apparatus of aspect 1A-13A, further comprising internal functional voids wherein low adjacent, channel-to-channel pressure differentials allow for thinner shared-wall thickness to contain pressures than would be required if individual channels were not adjoining and sharing one another's walls.

Aspect 15A: The apparatus of aspect 1A-14A, wherein one or more of the dip-tube device functional voids open to the parent container's internal void, thereby allowing fluid to pass freely between the parent container void and dip-tube device void through said port or opening. In some aspects, at least one opening can provide fluid communication between a functional void and a space defined between the exterior to the dip tube device body within the parent container. Said at least one opening can allow fluid to pass from space between from the functional void(s) inside the dip-tube device body and the space between the device and the inner wall of the parent vessel and vice versa. Such fluid flow can further permit equalization of pressures between the two as a much lower-priority function. In some aspects, dip tube device body can have a single opening. In some optional aspects, said single opening can be at, or proximate to, an end of the functional void.

Aspect 16A: A method of regulating and flow-control dip-tube comprising:
a. structural conformity to interval geometry of a container;
b. one or more internal functional voids which act as fluid channels;
c. corresponding inlet and outlet ports for each internal functional void allowing continuous, unobstructed fluid flow; and
d. internal configuration such that functional-void proximal orientations optimally tune parent-container efficiency, optimally tune parent-container residence times, and conform to parent-container internal footprint.

Aspect 17A: The method of aspect 16A further comprising operating as a performance-enhancing dip-tube device conformally fitted within a parent container in order to produce a variety of flow regimes not otherwise possible including, but not limited to, bubble flow, plug flow, annular flow.

Aspect 18A: The dip-tube device of the method of aspect 16A can serve as a de facto “dip tube” for said containers, requiring little or no modification to the container itself.

Aspect 19A: The dip-tube device of the method of aspect 16A, further comprising structures that are preferably embodied as a “dip tube” insert attached to pipes feeding through the lid into a parent container cavity and/or through said container body.

Aspect 20A: The function of the dip tube device of aspect 16A serving as a de facto “dip tube” in turn offers no direct capabilities as a standalone reaction containment device nor does it improve on any type of reaction containment device per se without a parent container, thus critically requiring a separate, parent container into which it is inserted for functional context.

Aspect 21A: The method of aspect 16A further comprising operation as a performance-enhancing dip-tube device for any of a variety of devices including, but not limited to, gasifiers, catalytic or non-catalytic reaction devices, molten-salt fissile devices, Fischer-Tropsch-process gas-to-liquid hydrocarbon-upgrading devices, supercritical-solvation or extraction devices, thermokinetic calorimeters, and any other suitably conceivable devices.

Aspect 22A: The method of aspect 16A further comprising modular apparatus operation in series in order to increase fluid-reaction-path length or modular parallel operation in order to increase fluid volumetric throughput capacity or modular operation in a combination of both serial and parallel configurations. For example, in some aspects, an apparatus can comprise a parent container with a plurality of dip tube device bodies within the parent container. In this way, a plurality of smaller dip tube device bodies can modularly form a desired flow path. In additional aspects, a system can comprise a plurality of parent containers can receive a respective dip tube device body (or a plurality of dip tube device bodies). In this way, the plurality of apparatuses can be used to modularly provide a desired flow path.

Aspect 1B: A device that is configured for receipt into an interior defined by a parent container, the device comprising:
a device body,
wherein the device body defines at least one flow path, wherein each flow path of the at least one flow path has an inlet and a corresponding outlet, and wherein the device body has an outer surface that is configured to be received within and circumferentially bias against the parent container.

Aspect 2B: The device of aspect 1B, wherein the at least one flow path comprises a plurality of helical segments that are fluidly coupled.

Aspect 3B: The device of any one aspect 1B or aspect 2B, wherein the outer surface of the body defines at least one groove that is configured to cooperate with the parent container to define an outer flow channel.

Aspect 4B: The device of any one of aspects 1B-3B, wherein the at least one flow path consists of a single flow path.

Aspect 5B: The device of any one of aspects 1B-4B, wherein the at least one flow path comprises a plurality of flow paths.

Aspect 6B: The device of aspect 5B, wherein the plurality of flow paths comprise a first flow path and a second flow path that at least partly surrounds the first flow path.

Aspect 7B: The device of aspect 5B, wherein the plurality of flow paths comprise a first flow path and a second flow path that are adjacent each other.

Aspect 8B: The device of any one of aspects 1B-7B, wherein the device body is formed by additive manufacturing.

Aspect 9B: The device of any one of aspects 1B-8B, wherein the device body comprises one or more of: metal, ceramic, sapphire, quartz, glass, or polymer.

Aspect 10B: The device of any one of aspects 1B-9B, wherein the device body comprises one or more of: iron, nickel, or gold.

Aspect 11B: The device of any one of aspects 1B-10B, wherein at least a portion of the device body is porous.

Aspect 12B: The device of any one of aspects 1B-11B, wherein the device body defines at least one opening that is configured to provide fluid communication between the at least one flow path and a volume defined between the parent container and the outer surface of the device body.

Aspect 13B: An apparatus comprising:
a parent container defining an interior; and
a device as in any one of aspects 1B-12B.

Aspect 14B: The apparatus of aspect 13B, wherein the device body and the at least one flow path cooperatively fill all or substantially all of the interior of the parent container.

Aspect 15B: The apparatus of aspect 13B or aspect 14B, wherein the outer surface of the device body conforms to the parent container.

Aspect 16B: The apparatus of any one of aspects 13B-15B, wherein the apparatus has a first pressure rating, wherein the device body has a second pressure rating below the first pressure rating when removed from the parent container.

Aspect 17B: The apparatus of aspect 16B, wherein the first pressure rating is at least 1000 psi.

Aspect 18B: A method of using the apparatus of any one of aspects 13B-17B, the method comprising:
flowing fluid through the at least one flow path.

Aspect 19B: The method of aspect 18B, wherein the at least one flow path comprises a first flow path and a second flow path, the method comprising:
flowing a first fluid through the first flow path; and
flowing a second fluid through the second flow path.

Aspect 20B: The method of aspect 18B, wherein flowing the fluid comprises mixing constituents of the fluid in the at least one flow path.

Aspect 21B: The method of any one of aspects 18B-20B, wherein the fluid is under a pressure of at least 200 psi.

What is claimed is:

1. A device that is configured for receipt into an interior defined by a parent container, the device comprising:
a device body,
wherein the device body defines at least one flow path, wherein each flow path of the at least one flow path has an inlet and a corresponding outlet, and wherein the device body has an outer surface that is configured to be received within and circumferentially bias against the parent container.

2. The device of claim 1, wherein the at least one flow path comprises a plurality of helical segments that are fluidly coupled.

3. The device of claim 1, wherein the outer surface of the body defines at least one groove that is configured to cooperate with the parent container to define an outer flow channel.

4. The device of claim 1, wherein the at least one flow path consists of a single flow path.

5. The device of claim 1, wherein the at least one flow path comprises a plurality of flow paths.

6. The device of claim 5, wherein the plurality of flow paths comprise a first flow path and a second flow path that at least partly surrounds the first flow path.

7. The device of claim 5, wherein the plurality of flow paths comprise a first flow path and a second flow path that are adjacent each other.

8. The device of claim 1, wherein the device body comprises one or more of:
metal, ceramic, sapphire, quartz, glass, or polymer.

9. The device of claim 1, wherein the device body comprises one or more of: iron, nickel, or gold.

10. The device of claim 1, wherein at least a portion of the device body is porous.

11. The device of claim 1, wherein the device body defines at least one opening that is configured to provide fluid communication between the at least one flow path and a volume defined between the parent container and the outer surface of the device body.

12. An apparatus comprising:
a parent container defining an interior; and
a device as in claim 1, wherein the device is at least partly received within the interior of the parent container.

13. The apparatus of claim 12, wherein the device body and the at least one flow path cooperatively fill all or substantially all of the interior of the parent container.

14. The apparatus of claim 12, wherein the outer surface of the device body conforms to the parent container.

15. The apparatus of claim 12, wherein the apparatus has a first pressure rating, wherein the device body has a second pressure rating below the first pressure rating when removed from the parent container.

16. The apparatus of claim 15, wherein the first pressure rating is at least 1000 psi.

17. A method of using the apparatus of claim 12, the method comprising:
flowing fluid through the at least one flow path.

18. The method of claim 17, wherein the at least one flow path comprises a first flow path and a second flow path, the method comprising:
flowing a first fluid through the first flow path; and
flowing a second fluid through the second flow path.

19. The method of claim 17, wherein flowing the fluid comprises mixing constituents of the fluid in the at least one flow path.

20. The method of claim 17, wherein the fluid is under a pressure of at least 200 psi.
